(19) United States
(12) Patent Application Publication
(10) Pub. No.: US 2026/0339066 A1
(43) Pub. Date: Oct. 29, 2026

(54) LENS BARREL ASSEMBLY WITH INTERCHANGEABLE LENS MODULE

(71) Applicant: SAMYANG OPTICS CO., LTD, Changwon-si (KR)

(72) Inventors: Soo Won YOON, Changwon-si (KR); Ji Hoon LEE, Changwon-si (KR)

(73) Assignee: SAMYANG OPTICS CO., LTD, Changwon-si (KR)

(21) Appl. No.: 19/252,031

(22) Filed: Jun. 27, 2025

(30) Foreign Application Priority Data
Apr. 29, 2025 (KR) 10-2025-0056361

(51) Int. Cl. G02B 7/14; G02B 7/04; G03B 7/20; G03B 17/14; G03B 17/56

(52) U.S. Cl. CPC G02B 7/14; G03B 7/20; G03B 17/14; G03B 17/565; G02B 7/04

(57) ABSTRACT

An interchangeable lens barrel assembly includes: a lens barrel that is detachably and exchangeably coupled to a camera body, and forms a lens hole at a center thereof; an interchangeable lens module that mounts at least one lens and is inserted into or removed from the lens hole of the lens barrel to be detachably and exchangeably attached to the lens barrel; and at least one positioning adjustment module that is provided on a circumferential surface of the interchangeable lens module and an inner circumferential surface of the lens hole, corresponding to the circumferential surface of the interchangeable lens module, and automatically adjusts a position of the interchangeable lens module when the interchangeable lens module is inserted into the lens hole.

### CROSS-REFERENCE TO RELATED APPLICATION

This application claims priority from Korean Patent Application No. 10-2025-0056361 filed on Apr. 29, 2025, in the Korean Intellectual Property Office, and all the benefits accruing therefrom under 35 U.S.C. 119, the contents of which in its entirety are herein incorporated by reference.

### BACKGROUND

### 1. Field

The present disclosure relates to an interchangeable lens barrel assembly, and more specifically, an interchangeable lens barrel assembly in which a common lens barrel, detachably provided to a camera body, is equipped with an interchangeable lens module that can be exchanged, such that when the interchangeable lens module is exchanged in the lens barrel, the position and fixation of the interchangeable lens module can be automatically adjusted, and furthermore, after coupling the lens barrel and the interchangeable lens module, aperture positioning and adjustment can also be automatically performed.

### 2. Description of the Related Art

Generally, a lens barrel assembly may be detachably provided to a camera body to capture an image of a subject. Such a lens barrel assembly as a detachable camera accessory (or optical device) is disclosed in U.S. Pat. No. 8,430,582 (Registration Date: Apr. 30, 2012, Title of Invention: Camera Accessory, Mount of Camera Accessory, Camera Body and Mount of Camera Body). This lens barrel assembly detachably provided to a camera body can be detachably mounted through a mount between the camera body and the lens barrel assembly.

The lens barrel assembly may include a lens barrel and a lens module.

The lens barrel may be detachably mounted to the front surface of the camera body to capture an image of a subject and may have a lens coupling hole formed therein to mount a lens module inside.

The lens module may be detachably coupled to the lens coupling hole of the lens barrel. The lens module may include at least one lens for guiding and forming an image of a subject and a lens body accommodating the lenses.

The lens barrel assembly can change the range of subjects to be captured with the camera position fixed. In addition, as the lens module is driven along the optical axis direction, the lenses may perform a zooming operation to adjust the magnification of a subject and a focusing operation to focus on the subject. That is, the lens barrel assembly can not only allow the lens module to be attached and detached but also perform zooming and focusing functions after the lens module is coupled.

Further, the lens barrel assembly, specifically the lens module, may be provided with an aperture module, and when the lens module is exchanged in the lens barrel, the aperture module is exchanged together with the lens module.

However, in assembling the lens module and the lens barrel, the aperture is adjusted using a manual operation method that requires rotating an external lever of the lens barrel.

Therefore, there is a need for an interchangeable lens barrel assembly that is detachably provided to a camera body and can be exchanged, where the interchangeable lens module can be automatically adjusted in position and fixed when exchanged in the lens barrel, and information of the interchangeable lens module can be recognized through contact points.

Furthermore, there is a need for an interchangeable lens barrel assembly that allows the positioning and adjustment of the aperture to be automatically adjusted after coupling the lens barrel and the interchangeable lens module.

### SUMMARY

One objective of the present disclosure is to provide an interchangeable lens barrel assembly in which a common lens barrel, detachably provided to a camera body, is equipped with an interchangeable lens module, the position and fixation of the interchangeable lens module can be automatically adjusted when the interchangeable lens module is exchanged in the lens barrel, and information of the interchangeable lens module can be recognized through contact points.

Another objective of the present disclosure is to provide an interchangeable lens barrel assembly that allows aperture positioning and adjustment to be automatically adjusted after coupling the lens barrel and the interchangeable lens module.

The objectives of the present disclosure are not limited to those mentioned above, and other objectives not explicitly stated will be clearly understood by those skilled in the art based on the following description.

According to an aspect of the present disclosure, there is provided an interchangeable lens barrel assembly including: a lens barrel that is detachably and exchangeably coupled to a camera body, and forms a lens hole at a center thereof; an interchangeable lens module that mounts at least one lens and is inserted into or removed from the lens hole of the lens barrel to be detachably and exchangeably attached to the lens barrel; and at least one positioning adjustment module that is provided on a circumferential surface of the interchangeable lens module and an inner circumferential surface of the lens hole, corresponding to the circumferential surface of the interchangeable lens module, and automatically adjusts a position of the interchangeable lens module when the interchangeable lens module is inserted into the lens hole.

The at least one positioning adjustment module is arranged on an upper circumferential surface area of the interchangeable lens module and an upper inner surface area of the lens hole.

The at least one positioning adjustment module includes: at least one first positioning magnet provided on an upper circumferential surface area of the interchangeable lens module; and at least one second positioning magnet provided on an upper inner circumferential surface area of the lens hole at a position corresponding to the first positioning magnet, and when the interchangeable lens module is inserted into the lens hole, the interchangeable lens module is rotated within the lens hole by magnetic forces of the at least one first positioning magnet and at least one second positioning magnet such that the position of the interchangeable lens module is automatically adjusted.

The interchangeable lens module includes: a lens housing; and a lens module including an upper lens member and a rear lens module that are laminated and mounted axially inside the lens housing.

A seating ring, which protrudes along a circumference of the lens housing, is provided at an upper end of the lens housing, and a seating groove, in which the seating ring is seated, is provided along an upper circumference of the lens hole, on a top surface of the lens barrel.

A lens recognition module, which is configured to recognize information of the interchangeable lens module, is further provided on a lower surface of the seating ring and an upper surface of the seating groove.

When the interchangeable lens module is inserted and fixed into the lens hole, the lower surface of the seating ring and the upper surface of the seating groove come into contact, and the lens recognition module is electrically connected to recognize the information of the interchangeable lens module.

The lens recognition module includes: a first connector provided on the lower surface of the seating ring; and a second connector provided on the upper surface of the seating groove to face the first connector and be connected to the first connector.

When the interchangeable lens module is inserted into the lens hole and its position is adjusted, and then the seating ring is placed on the upper surface of the seating groove, the first and second connectors come into contact and are electrically connected, and the information of the interchangeable lens module is automatically transmitted to the camera body through the lens barrel.

An aperture module is provided in the interchangeable lens module and the lens barrel, between the upper lens member and the rear lens module.

The aperture module includes: an aperture control plate provided between the upper lens member and the rear lens module, inside the lens housing, the aperture control plate forming an opening of a basic size and configured to adjust a size of the opening; and an aperture control ring arranged along a circumference of the aperture control plate, inside the lens barrel, and driven to adjust an opening area of the opening of the aperture module in accordance with the aperture control plate.

The aperture module is provided with an aperture adjustment module, which is configured to adjust the aperture module.

The aperture adjustment module includes: a first aperture adjustment member including a first mounting part positioned on a side surface of the lens housing and formed axially at an outer end of the aperture control plate, and a first aperture adjustment magnet seated in the first mounting part; and a second aperture adjustment member including a second mounting part positioned on a circumferential surface of the lens hole, on an inner surface of the aperture control ring, and formed axially, and a second aperture adjustment magnet mounted in the second mounting part and engaging with the first aperture adjustment magnet.

When the interchangeable lens module is inserted and fixed into the lens hole, the first and second aperture adjustment magnets face each other, and as an aperture control signal is applied from the camera body, the second aperture adjustment magnet is rotated upon rotation of the aperture control ring, thereby adjusting an opening area of the opening of the aperture module.

According to the aforementioned embodiments of the present disclosure, at least the following effects can be achieved.

A common lens barrel, detachably provided to a camera body and capable of being exchanged, is equipped with an interchangeable lens module, at least one first positioning magnet unit provided on an outer circumferential surface of the interchangeable lens module, and at least one second positioning magnet provided in the lens hole of a lens barrel to engage with the first positioning magnet, thus enabling the position and fixation of the interchangeable lens module to be automatically adjusted when exchanging the interchangeable lens module in the lens barrel.

In addition, by providing a first connector provided on the lower surface of a seating ring of the interchangeable lens module and a second connector provided in a seating groove of the lens barrel, once the interchangeable lens module is inserted into the lens barrel and its position is adjusted, the first and second connectors are brought into contact and connected, allowing information of the interchangeable lens module to be supplied to the camera body through the lens barrel and thus enabling automatic recognition of the interchangeable lens module's information.

Moreover, by providing a first aperture adjustment member inside the lens housing of the interchangeable lens module and a second aperture adjustment member corresponding to the first aperture adjustment member in the lens barrel, when the second aperture adjustment magnet is rotated by gear driving of the lens barrel with the first and second aperture adjustment magnets facing each other, an aperture control plate is automatically rotated by the magnetic force between the first and second aperture adjustment magnets, thereby automatically adjusting the aperture area.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is an assembled perspective view of an interchangeable lens barrel assembly according to an embodiment of the present disclosure;

FIG. 2 is an exploded perspective view, in one direction, of a lens barrel and interchangeable lens module of the interchangeable lens barrel assembly according to an embodiment of the present disclosure;

FIG. 3 is an exploded perspective view, in another direction, of the lens barrel and interchangeable lens module of the interchangeable lens barrel assembly according to an embodiment of the present disclosure;

FIG. 4 is a cross-sectional view of at least one positioning adjustment module of the interchangeable lens barrel assembly according to an embodiment of the present disclosure;

FIG. 5 is a perspective view of a lens recognition module in the interchangeable lens barrel assembly according to an embodiment of the present disclosure;

FIG. 6 shows perspective views, in various directions, of the lens recognition module in the interchangeable lens barrel assembly according to an embodiment of the present disclosure;

FIG. 7 is a cross-sectional view of an aperture module and aperture adjustment module in the interchangeable lens barrel assembly according to an embodiment of the present disclosure;

FIG. 8 is an exploded perspective view of the aperture module and aperture adjustment module in the interchangeable lens module and lens barrel of the interchangeable lens barrel assembly according to an embodiment of the present disclosure;

FIG. 9 is an exploded cut-away perspective view of the aperture module and aperture adjustment module in the interchangeable lens module and lens barrel of the interchangeable lens barrel assembly according to an embodiment of the present disclosure;

FIG. 10 is an exploded cross-sectional view of the aperture module and aperture adjustment module in the interchangeable lens module and lens barrel of the interchangeable lens barrel assembly according to an embodiment of the present disclosure;

FIG. 11 is a perspective view of the aperture module and aperture adjustment module in the interchangeable lens barrel assembly according to an embodiment of the present disclosure; and

FIG. 12 is a plan view of the aperture module and aperture adjustment module in the interchangeable lens barrel assembly according to an embodiment of the present disclosure.

### DETAILED DESCRIPTION

Advantages and features of the disclosure and methods to achieve them will become apparent from the descriptions of exemplary embodiments herein below with reference to the accompanying drawings. However, the inventive concept is not limited to exemplary embodiments disclosed herein but may be implemented in various ways. The exemplary embodiments are provided for making the disclosure of the inventive concept thorough and for fully conveying the scope of the inventive concept to those skilled in the art. It is to be noted that the scope of the disclosure is defined only by the claims. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

Terms used herein are for illustrating the embodiments rather than limiting the present disclosure. As used herein, the singular forms are intended to include plural forms as well, unless the context clearly indicates otherwise. Throughout this specification, the word “comprise” and variations such as “comprises” or “comprising,” will be understood to imply the inclusion of stated elements but not the exclusion of any other elements.

Hereinafter, exemplary embodiments of the present disclosure will be described in detail with reference to the accompanying drawings.

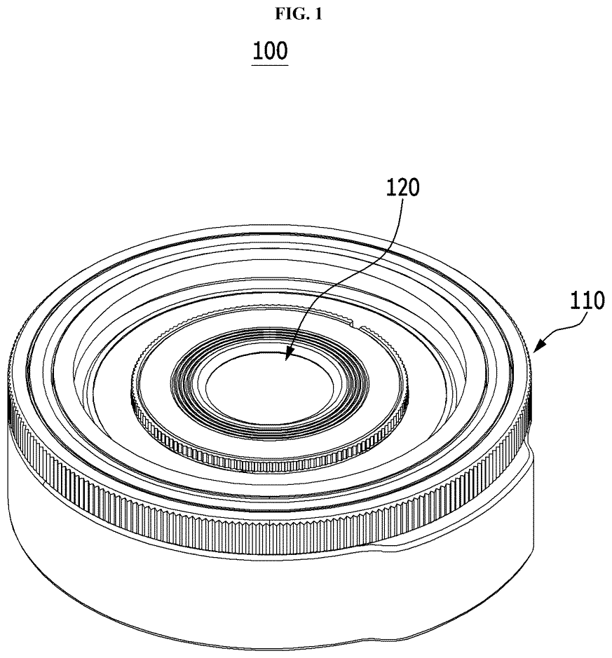

FIG. 1 is an assembled perspective view of an interchangeable lens barrel assembly 100 according to an embodiment of the present disclosure.

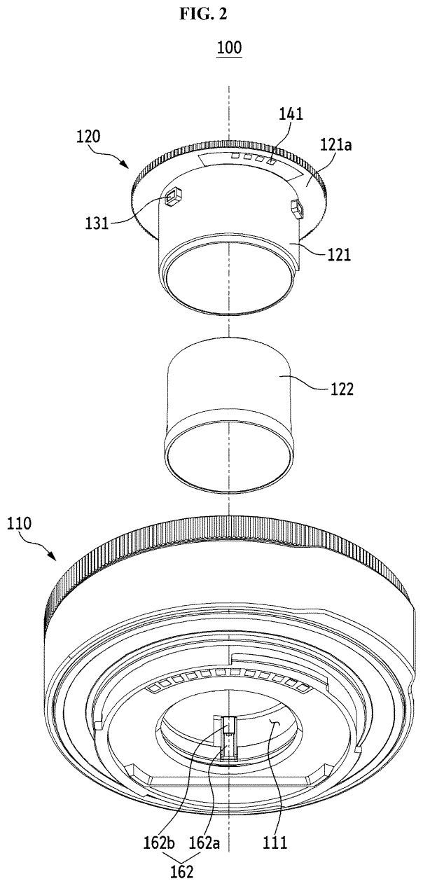

FIG. 2 is an exploded perspective view, in one direction, of a lens barrel 110 and interchangeable lens module 120 of the interchangeable lens barrel assembly 100.

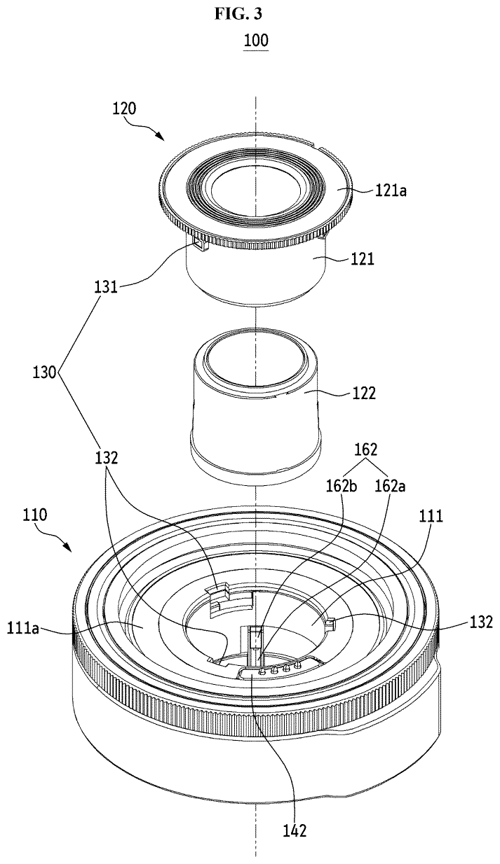

FIG. 3 is an exploded perspective view, in another direction, of the lens barrel 110 and the interchangeable lens module 120.

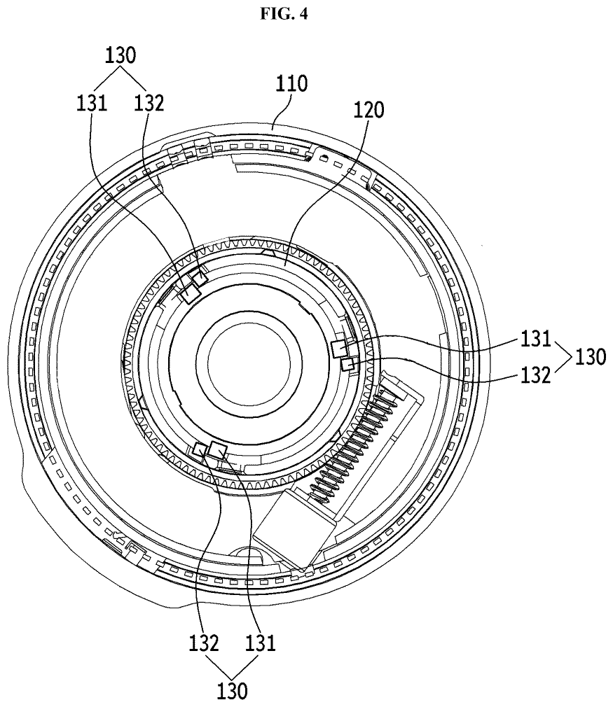

FIG. 4 is a cross-sectional view of at least one positioning adjustment module 130 of the interchangeable lens barrel assembly 100.

Referring to FIGS. 1 through 4, the interchangeable lens barrel assembly 100 may include the lens barrel 110, the interchangeable lens module 120, and the at least one positioning adjustment module 130. As will be described later, the interchangeable lens barrel assembly 100 may also include a lens recognition module 140, an aperture module 150, and an aperture adjustment module 160.

The lens barrel 110 may be detachably coupled to a camera body in an exchangeable manner, and may be provided with a lens hole 111 formed in the middle in a donut shape to allow the interchangeable lens module 120 to be detachably provided.

The interchangeable lens module 120 may be configured to mount at least one lens therein. The interchangeable lens module 120 may be inserted into and fixed to or removed from the lens hole 111 of the lens barrel 110, and may thus be detachably attached to the lens barrel 110 in an exchangeable manner.

The interchangeable lens module 120 may include a lens housing 121 and a lens module 122.

The lens housing 121 may be formed with a T-shaped cross-section and may be hollow inside to accommodate some of the components of the lens module 122 and the aperture module 150 to be described later.

The lens module 122 may include an upper lens member 122a and a lower lens member 122b that are laminated and mounted axially inside the lens housing 121.

The at least one positioning adjustment module 130 may be provided so that the lens barrel 110 and the interchangeable lens module 120 face each other. Specifically, at least one positioning adjustment module 130 may be provided on the circumferential surface of the interchangeable lens module 120 and on the inner circumferential surface of the lens hole 111 corresponding to the circumferential surface of the interchangeable lens module 120. When the interchangeable lens module 120 is inserted into the lens hole 111, the position of the interchangeable lens module 120 may be automatically adjusted through the at least one positioning adjustment module 130.

The at least one positioning adjustment module 130 may be positioned in an upper circumferential surface area of the interchangeable lens module 120, specifically in an upper circumferential surface area the lens housing 121 and an upper inner circumferential surface area of the lens hole 111.

The at least one positioning adjustment module 130 may include one or more first positioning magnets 131 and one or more second positioning magnets 132.

At least one first positioning magnet 131 may be provided in the upper circumferential surface area of the lens housing 121 of the interchangeable lens module 120.

At least one second positioning magnet 132 may be provided in the upper inner circumferential surface area of the lens hole 111 to correspond to the at least one first positioning magnet 131.

When the interchangeable lens module 120 is inserted into the lens hole 111, the interchangeable lens module 120 rotates within the lens hole 111 due to the magnetic forces of the at least one first positioning magnet 131 and the at least one second positioning magnet 132. As the interchangeable lens module 120 rotates, the least one first positioning magnet 131 and the least one second positioning magnet 132 face and align with each other, and the position of the interchangeable lens module 120 may be automatically adjusted.

In this embodiment, for example, three first positioning magnets 131 may be provided at 120-degree intervals in the upper circumferential surface area of the lens housing 121, and three second positioning magnets 132 may be provided at 120-degree intervals in the upper inner circumferential surface area of the lens hole 111 to correspond to the three first positioning magnets 131, respectively.

A seating ring 121a may be provided at the upper end of the lens housing 121 to protrude along the circumference of the lens housing 121, and a seating groove 111a, in which the seating ring 121a is seated, may be provided along the upper circumferential end of the lens hole 111 on the top surface of the lens barrel 110.

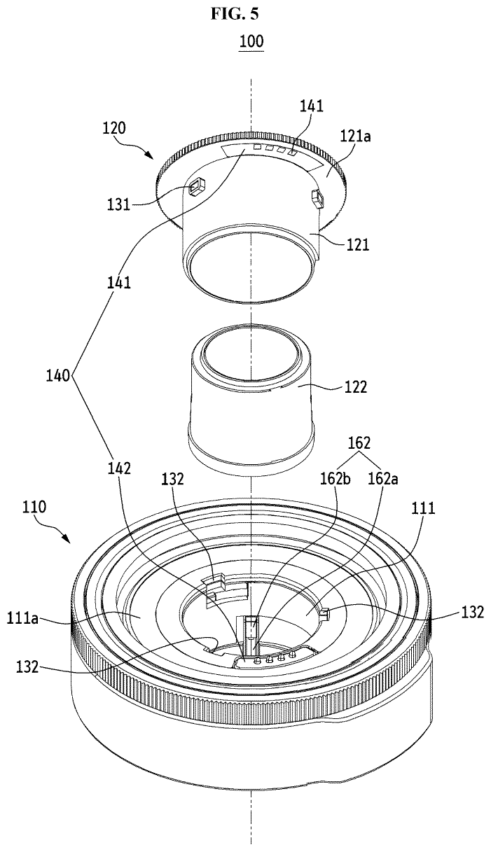

FIG. 5 is a perspective view of the lens recognition module 140 in the interchangeable lens barrel assembly 100.

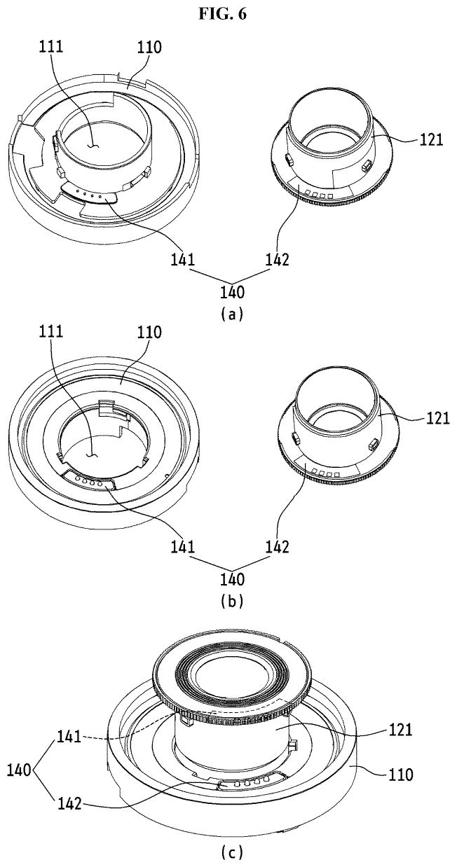

FIG. 6 shows perspective views, in various directions, of the lens recognition module 140 in the interchangeable lens barrel assembly 100 according to an embodiment of the present disclosure.

Referring to FIGS. 5 and 6, as described above, the interchangeable lens module 120 is configured to be attachable to and detachable from the lens barrel 110. As the lens specifications vary depending on the specifications of the interchangeable lens module 120, the interchangeable lens barrel assembly 100 may be provided with a device for recognizing the specifications (or information) of the interchangeable lens module 120, specifically, the lens recognition module 140.

The lens recognition module 140 may be provided in the seating ring 121a of the interchangeable lens module 120 and the seating groove 111a of the lens barrel 110 to recognize the information of the interchangeable lens module 120 that is exchanged by being attached to and detached from the lens barrel 110.

Specifically, the lens recognition module 140 may be provided at positions corresponding to the lower surface of the seating ring 121a and the upper surface of the seating groove 111a, such that when the interchangeable lens module 120 is inserted into the lens hole 111, the upper surface of the seating groove 111a and the lower surface of the seating ring 121a come into contact and are electrically connected, thereby recognizing the information of the interchangeable lens module 120.

The lens recognition module 140 may include a first connector 141 and a second connector 142.

The first connector 141 may be provided on the lower surface of the seating ring 121a and may be configured to be electrically connected by contacting the second connector 142 to be described later.

The second connector 142 may be provided on the upper surface of the seating groove 111a to face the first connector 141 and be connected to the first connector 141.

When the interchangeable lens module 120 is inserted into the lens hole 111 and its position is adjusted, and then, the seating ring 121a is placed on the upper surface of the seating groove 111a, the first and second connectors 141 and 142 may come into contact and be electrically connected. Through the electrical contact between the first and second connectors 141 and 142, the information of the interchangeable lens module 120 may be automatically transmitted to the camera body via the lens barrel 110.

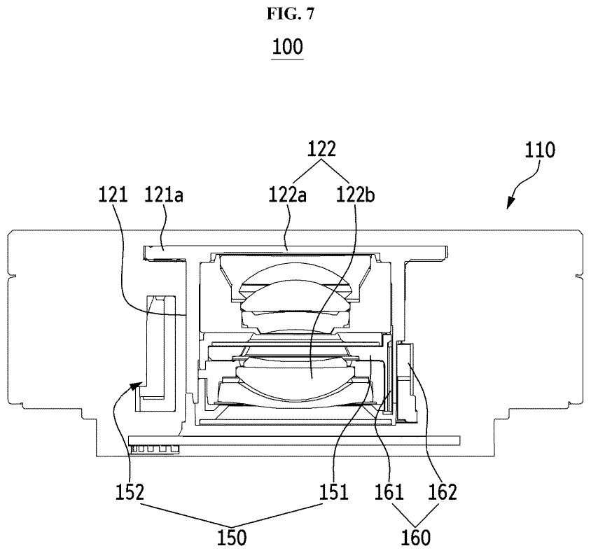

FIG. 7 is a cross-sectional view illustrating the aperture module 150 and the aperture adjustment module 160 in the interchangeable lens barrel assembly 100.

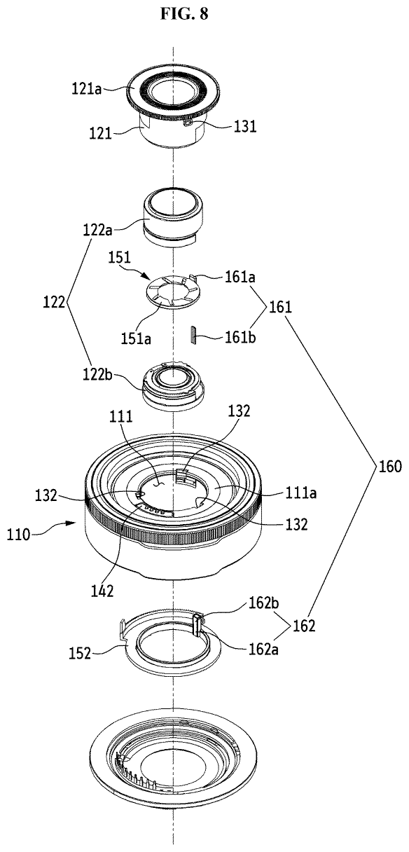

FIG. 8 is an exploded perspective view of the aperture module 150 and the aperture adjustment module 160 in the interchangeable lens module 120 and the lens barrel 110 of the interchangeable lens barrel assembly 100.

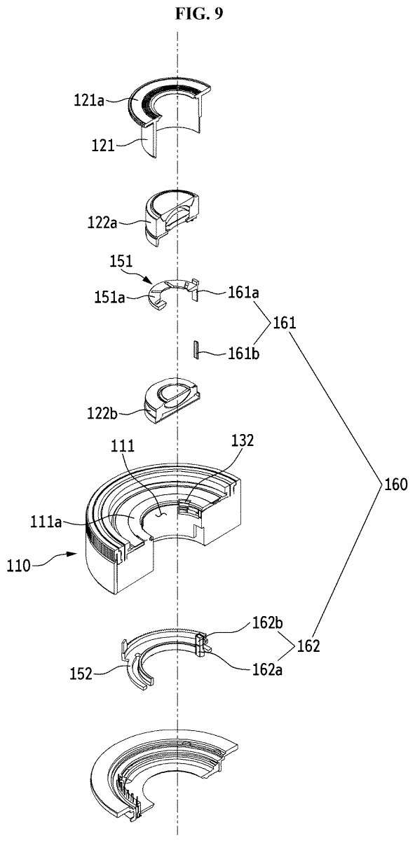

FIG. 9 is an exploded cut-away perspective view of the aperture module 150 and the aperture adjustment module 160 in the interchangeable lens module 120 and the lens barrel 110 of the interchangeable lens barrel assembly 100.

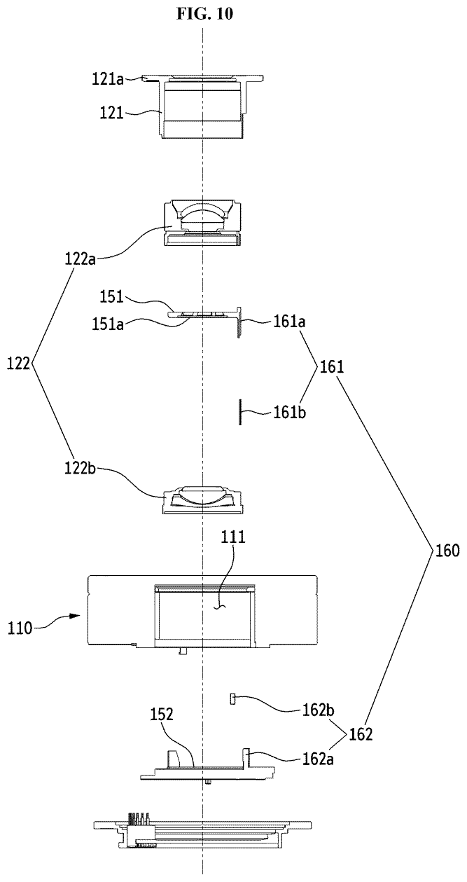

FIG. 10 is an exploded cross-sectional view of the aperture module 150 and the aperture adjustment module 160 in the interchangeable lens module 120 and the lens barrel 110 of the interchangeable lens barrel assembly 100.

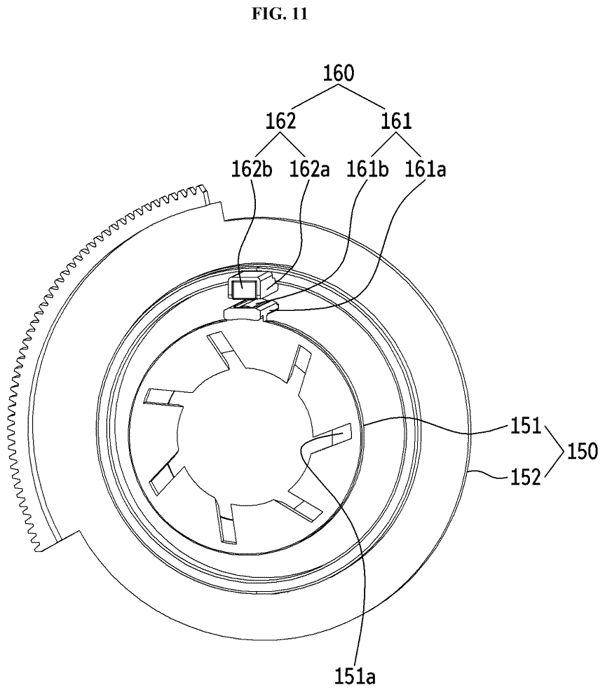

FIG. 11 is a perspective view of the aperture module 150 and the aperture adjustment module 160 in the interchangeable lens barrel assembly 100.

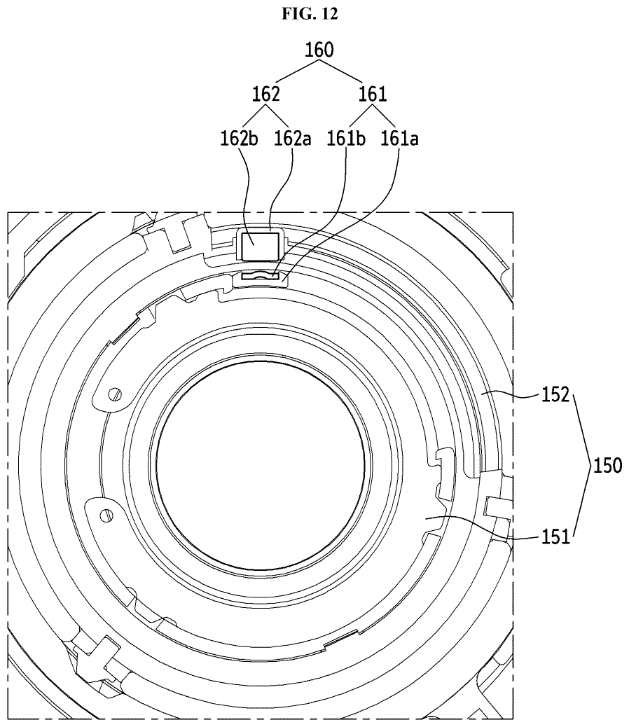

FIG. 12 is a plan view of the aperture module 150 and the aperture adjustment module 160 in the interchangeable lens barrel assembly 100.

Referring to FIGS. 7 through 12, the interchangeable lens barrel assembly 100 may include the aperture module 150.

The aperture module 150 may be provided so as to engage with the interchangeable lens module 120 and the lens barrel 110, between an upper lens member 122a and a lower lens member 122b.

The aperture module 150 may include an aperture control plate 151 and an aperture control ring 152.

The aperture control plate 151 may be provided inside the lens housing 121, and particularly, between the upper and lower lens members 122a and 122b. The aperture control plate 151 may form an opening 151a of a basic size and may be configured to adjust the size of the opening 151a.

The aperture control ring 152 may be provided inside the lens barrel 110 and may be arranged along the circumference of the aperture control plate 151. The aperture control ring 152 may be rotationally driven under the control of the camera body, and accordingly, the aperture control plate 151 may be configured to adjust the opening area of the opening 151a of the aperture module 150.

When the interchangeable lens module 120 is inserted into the lens hole 111 in the interchangeable lens barrel assembly 100, the aperture adjustment module 160 may automatically adjust the aperture module 150.

The aperture adjustment module 160 may include a first aperture adjustment member 161 and a second aperture adjustment member 162.

The first aperture adjustment member 161 may be provided on the aperture control plate 151. Specifically, the first aperture adjustment member 161 may include a first mounting part 161a and a first aperture adjustment magnet 161b. The first mounting part 161a may be positioned on a side surface of the lens housing 121 and may be formed axially at an outer end of the aperture control plate 151. A first receiving groove may be formed in the first mounting part 161a to accommodate the first aperture adjustment magnet 161b. The first aperture adjustment magnet 161b may be seated and fixed in the first receiving groove of the first mounting part 161a and may be positioned to face a second aperture adjustment magnet 162b to be described below.

The second aperture adjustment member 162 may be provided in the lens barrel 110 at a position corresponding to the first aperture adjustment magnet 161b. Specifically, the second aperture adjustment member 162 may include a second mounting part 162a and the second aperture adjustment magnet 162b. The second mounting part 162a may be positioned at an inner circumferential surface of the aperture control ring 152, on the circumferential surface of the lens hole 111, and may be formed axially. A second receiving groove may be formed in the second mounting part 162a to accommodate the second aperture adjustment magnet 162b. The second aperture adjustment magnet 162b may be seated and fixed in the second receiving groove of the second mounting part 162a. The second aperture adjustment magnet 162b may engage with the first aperture adjustment magnet 161b, thereby generating a magnetic force.

When the interchangeable lens module 122 is inserted and fixed into the lens hole 111, the first and second aperture adjustment magnets 161b and 162b may be arranged to face each other.

When an aperture control signal is applied from the camera body, the aperture control ring 152 may be rotated by the corresponding gear structure (illustrated in FIG. 4). When the aperture control ring 152 is rotationally driven, the second aperture adjustment magnet 162b is rotated together with the aperture control ring 152. As the first aperture adjustment magnet 161b generates a magnetic force by facing and magnetically engaging with the second aperture adjustment magnet 162b, the first aperture adjustment magnet 161b may rotate together with the second aperture adjustment magnet 162b upon the rotation of the second aperture adjustment magnet 162b. When the first aperture adjustment magnet 161b rotates, the opening area of the opening 151a of the aperture module 150 may be adjusted and varied.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. An interchangeable lens barrel assembly comprising:
a lens barrel that is detachably and exchangeably coupled to a camera body, and forms a lens hole at a center thereof;
an interchangeable lens module that mounts at least one lens and is inserted into or removed from the lens hole of the lens barrel to be detachably and exchangeably attached to the lens barrel; and
at least one positioning adjustment module that is provided on a circumferential surface of the interchangeable lens module and an inner circumferential surface of the lens hole, corresponding to the circumferential surface of the interchangeable lens module, and automatically adjusts a position of the interchangeable lens module when the interchangeable lens module is inserted into the lens hole.

2. The interchangeable lens barrel assembly of claim 1, wherein the at least one positioning adjustment module is arranged on an upper circumferential surface area of the interchangeable lens module and an upper inner surface area of the lens hole.

3. The interchangeable lens barrel assembly of claim 1, wherein
the at least one positioning adjustment module includes: at least one first positioning magnet provided on an upper circumferential surface area of the interchangeable lens module;
and at least one second positioning magnet provided on an upper inner circumferential surface area of the lens hole at a position corresponding to the first positioning magnet, and
when the interchangeable lens module is inserted into the lens hole, the interchangeable lens module is rotated within the lens hole by magnetic forces of the at least one first positioning magnet and at least one second positioning magnet such that the position of the interchangeable lens module is automatically adjusted.

4. The interchangeable lens barrel assembly of claim 1, wherein the interchangeable lens module includes: a lens housing; and a lens module including an upper lens member and a rear lens module that are laminated and mounted axially inside the lens housing.

5. The interchangeable lens barrel assembly of claim 4, wherein
a seating ring, which protrudes along a circumference of the lens housing, is provided at an upper end of the lens housing, and
a seating groove, in which the seating ring is seated, is provided along an upper circumference of the lens hole, on a top surface of the lens barrel.

6. The interchangeable lens barrel assembly of claim 5, wherein a lens recognition module, which is configured to recognize information of the interchangeable lens module, is further provided on a lower surface of the seating ring and an upper surface of the seating groove.

7. The interchangeable lens barrel assembly of claim 6, wherein when the interchangeable lens module is inserted and fixed into the lens hole, the lower surface of the seating ring and the upper surface of the seating groove come into contact, and the lens recognition module is electrically connected to recognize the information of the interchangeable lens module.

8. The interchangeable lens barrel assembly of claim 7, wherein the lens recognition module includes: a first connector provided on the lower surface of the seating ring; and a second connector provided on the upper surface of the seating groove to face the first connector and be connected to the first connector.

9. The interchangeable lens barrel assembly of claim 8, wherein when the interchangeable lens module is inserted into the lens hole and its position is adjusted, and then the seating ring is placed on the upper surface of the seating groove, the first and second connectors come into contact and are electrically connected, and the information of the interchangeable lens module is automatically transmitted to the camera body through the lens barrel.

10. The interchangeable lens barrel assembly of claim 1, wherein an aperture module is provided in the interchangeable lens module and the lens barrel, between the upper lens member and the rear lens module.

11. The interchangeable lens barrel assembly of claim 10, wherein the aperture module includes: an aperture control plate provided between the upper lens member and the rear lens module, inside the lens housing, the aperture control plate forming an opening of a basic size and configured to adjust a size of the opening; and an aperture control ring arranged along a circumference of the aperture control plate, inside the lens barrel, and driven to adjust an opening area of the opening of the aperture module in accordance with the aperture control plate.

12. The interchangeable lens barrel assembly of claim 11, wherein the aperture module is provided with an aperture adjustment module, which is configured to adjust the aperture module.

13. The interchangeable lens barrel assembly of claim 12, wherein the aperture adjustment module includes: a first aperture adjustment member including a first mounting part positioned on a side surface of the lens housing and formed axially at an outer end of the aperture control plate, and a first aperture adjustment magnet seated in the first mounting part; and a second aperture adjustment member including a second mounting part positioned on a circumferential surface of the lens hole, on an inner surface of the aperture control ring, and formed axially, and a second aperture adjustment magnet mounted in the second mounting part and engaging with the first aperture adjustment magnet.

14. The interchangeable lens barrel assembly of claim 13, wherein
when the interchangeable lens module is inserted and fixed into the lens hole, the first and second aperture adjustment magnets face each other, and
as an aperture control signal is applied from the camera body, the second aperture adjustment magnet is rotated upon rotation of the aperture control ring, thereby adjusting an opening area of the opening of the aperture module.
